(19) United States
(12) Patent Application Publication
(10) Pub. No.: US 2010/0000066 A1
(43) Pub. Date: Jan. 7, 2010

(54) METHOD FOR ASSEMBLING DE-ICING MATTING AND A METAL SHIELD ON A STRUCTURE

(75) Inventor: Loic Boissy, Caudebec Les Elbeufs (FR)

Correspondence Address: CASELLA & HESPOS, 274 MADISON AVENUE, NEW YORK, NY, 10016, US

(73) Assignee: AERAZUR, Issy Les Moulineaux (FR)

(21) Appl. No.: 12/498,559

(22) Filed: Jul. 7, 2009

(30) Foreign Application Priority Data
Jul. 7, 2008 (FR) 08 54593

(51) Int. Cl. B23P 11/00

(52) U.S. Cl. 29/428

(57) ABSTRACT

Method for assembling de-icing matting (3) and an external protective metal shield (2), on a structure (1), such as an airfoil leading edge structure (1), comprising the following steps: manufacture of de-icing matting (3) independent of said structure (1), installation of the de-icing matting (3), between said structure (1) and the metal shield (2), said de-icing matting (3) covering only a portion (4) of the external surface of said structure (1), attachment of said metal shield (2), entirely covering said de-icing matting (3), to the portion (5) of the external surface of said structure (1) not covered by said de-icing matting (3).

### BACKGROUND OF THE INVENTION

1. Field of the Invention

The present invention relates to a method for assembling de-icing matting and a metal shield on a structure.

2. Description of the Related Art

It is known practice to produce, as illustrated in FIG. 1, a structure 12 such as an airfoil leading edge structure, in metal or composite. Conventionally, such a structure is protected by a metal shield 13 covering its external surface. The purpose of this metal shield 13 is to provide external protection in order to protect the structure 12 from erosion, from impacts and more generally from the environment. This shield 13 is moreover conductive in order to have surface electric continuity making it possible to carry away any lightening strikes. However, this metal shield 13 is in contact with the extreme environmental conditions encountered by an aviation airfoil part and is subject to icing. For the purposes of de-icing or anti-icing of the external surface of the metal shield 13, the structure 12 advantageously comprises a means 14 for de-icing or for anti-icing. This means 14, for example a heating means 14, is, in a conventional manner, intimately incorporated into the structure 12. In order to allow a perfect assembly, the metal shield 13 and the structure 12 may be vulcanized together.

Such a definition and manufacture make any removal of the metal shield 13 impossible without destroying the structure 12. It is therefore impossible to replace the de-icing or anti-icing means 14. Any maintenance requires complete replacement of the assembly comprising structure/shield/de-icing or anti-icing means.

One object of the present invention is to make possible removal of the metal shield, replacement of the structure, replacement of the shield or else replacement of the de-icing or anti-icing means.

### SUMMARY OF THE INVENTION

For this, the invention proposes a method for assembling de-icing matting and an external protective metal shield, on a structure, such as an airfoil leading edge structure, comprising the following steps: manufacture of de-icing matting independent of said structure, installation of the de-icing matting, between said structure and the metal shield, said de-icing matting covering only a portion of the external surface of said structure, attachment of said metal shield, entirely covering said de-icing matting, to the portion of the external surface of said structure not covered by the de-icing matting.

According to another feature of the invention, the de-icing matting comprises an elastomer matrix.

Alternatively or additionally, the de-icing matting comprises a composite matrix.

According to another feature of the invention, the de-icing matting comprises a network of heating resistances made of metal.

Alternatively or additionally, the de-icing matting comprises a network of heating resistances made of conductive fibers.

According to another feature of the invention, the structure has, on its external face, a housing capable of accommodating the de-icing matting.

According to another feature of the invention, the structure is metal or composite.

According to another feature of the invention, the metal shield has a reduced thickness in the portion covering the de-icing matting and an increased thickness in the portion not covering the de-icing matting.

According to another feature of the invention, the de-icing matting is installed by prior assembly with the metal shield.

According to another feature of the invention, the de-icing matting is bonded to the metal shield.

According to another feature of the invention, the composite de-icing matting is drape-molded directly over the metal shield.

According to another feature of the invention, the de-icing matting is installed by prior assembly with the structure.

According to another feature of the invention, the attachment of the metal shield to the structure is carried out by riveting or by screwing.

According to another feature of the invention, the assembly method further comprises a step of injecting a filler material into a space delimited between the de-icing matting and the structure.

According to another feature of the invention, the filler material is chosen from a silicone gel, an elastomer in the form of self-vulcanizing paste or gel and a polyurethane foam.

The invention will now be described in greater detail with reference to particular embodiments given for illustration purposes only and shown in the appended figures.

### BRIEF DESCRIPTION OF THE DRAWINGS

FIG. 1 is a sectional view in perspective of an object according to the prior art and has already been described.

FIGS. 2 and 3 are sectional views in perspective of an object obtained by the method according to the invention.

FIG. 4 is another view in section of an object obtained by the method according to the invention.

FIG. 5 is another sectional view in perspective illustrating another embodiment of an object obtained by the method according to the invention.

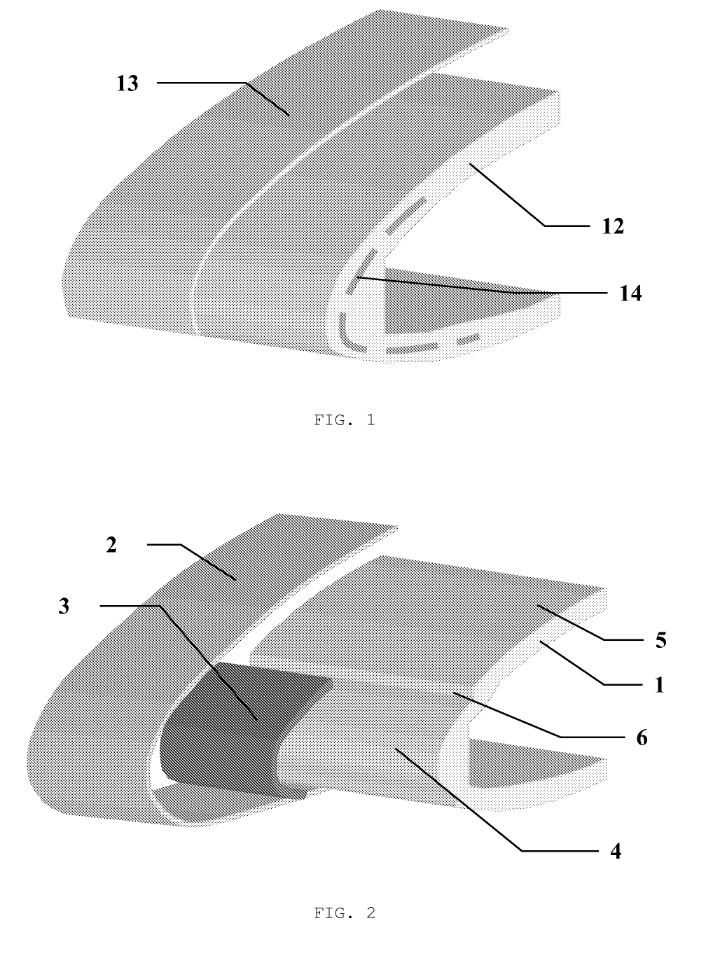

### DETAILED DESCRIPTION OF THE PREFERRED EMBODIMENTS

It goes without saying that the detailed description of the object of the invention, given only as an illustration, in no way constitutes a limitation, the technical equivalents also being included in the field of the present invention.

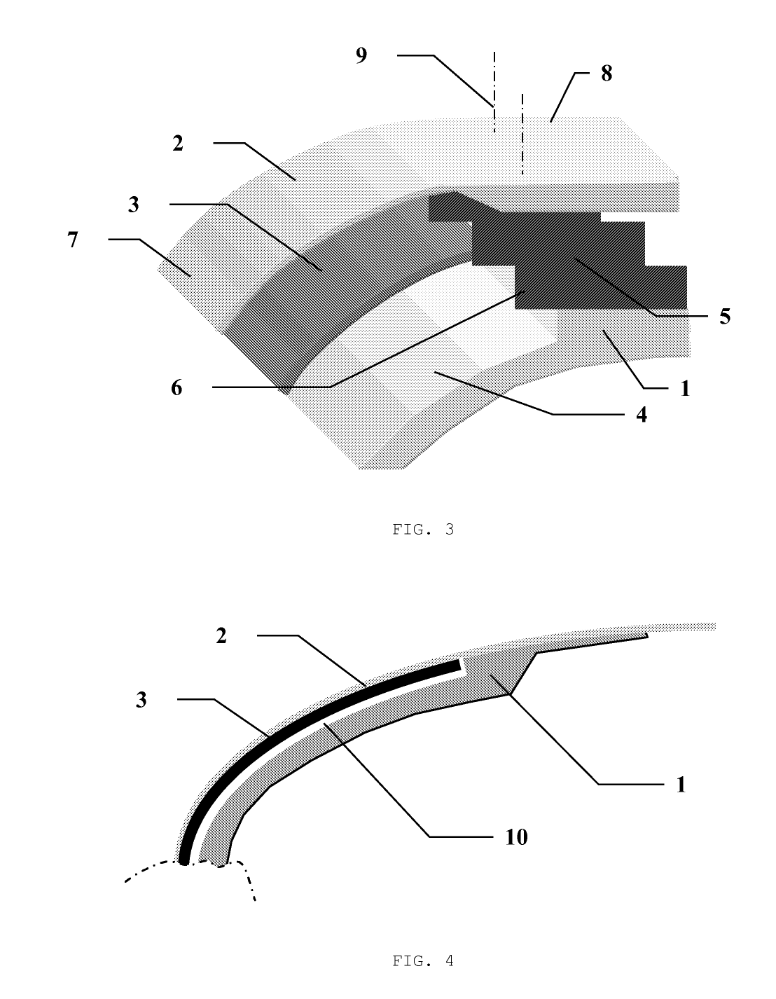

With reference to FIG. 2, the principle of the invention appears clearly. It consists in replacing the de-icing means 14 incorporated into the structure 12 with a de-icing matting 3 that is independent of the structure 1, and in assembling the assembly by placing said de-icing matting 3 between the structure 1 and the metal shield 2.

For this, the method assembles a de-icing matting 3 and an external protective metal shield 2 on a structure 1. The structure 1 is typically an airfoil leading edge structure 1. It may be an edge of a wing, of a tail or of a control surface of an aircraft or else an edge of a helicopter rotor blade. The method of assembly comprises the following steps.

A first step consists in manufacturing de-icing matting 3 independent of said structure 1. This makes it possible to form a “de-icing matting” maintenance entity which can be replaced independently. Moreover, said de-icing matting 3 is manufactured in a standalone manner. It is controlled in terms of correct operation, of electrical insulation, of electrical characteristics before its installation on the structure 1. In contrast, manufacturing according to the prior art requires the complete production of the integrated structure 12, before being able to carry out the tests. Therefore the invention advantageously reduces the scrapping costs.

In a second step, the de-icing matting 3 is installed between the structure 1 and the metal shield 2. Advantageously, the de-icing matting 3 covers only a portion 4 of the external surface of said structure 1. Therefore, in FIG. 2, the covered portion is the portion of the leading edge that is the most prone to icing.

A third step consists in attaching the metal shield 2. The latter entirely covers said de-icing matting 3 and furthermore overlaps onto a portion 5 of the external surface of the structure 1, which is not covered by the de-icing matting 3. The de-icing matting 3 is therefore incorporated between the structure 1 and the metal shield 2 and covers a portion of covered surface 4. The metal shield 2 is directly in contact with the structure 1 over an uncovered portion 5. This uncovered portion 5 is advantageously used for carrying out the attachment of the metal shield 2 directly to the structure 1.

The de-icing matting 3 may be heating matting 3. This heating matting 3 is conventionally made by heating resistances incorporated into a matrix maintaining and protecting said heating resistances.

According to a first embodiment, said matrix is made of elastomer. It may be nitrile, polyurethane or else polychloroprene. This elastomer matrix may also be reinforced by glass or polyamide fabric.

According to a second embodiment, said matrix is composite. It is then made by draping, according to the methods known to those skilled in the art, of two composite layers framing the network of heating resistances.

Said heating resistances may be produced by means of a network of heating resistances made of metal.

Alternatively, said heating resistances may be produced by means of a network of heating resistances made of conductive fibers. Such conductive fibers are for example fibers that are discontinuous and conductive of electricity, these fibers preferably having a length at most equal to 50 mm, for example from 0.1 to 50 mm.

Preferably, the above-mentioned fibers each comprise a core covered with an electrically conductive metal; the core advantageously consists of a material chosen from the group consisting of a carbon fiber, a natural fiber, a polyester fiber, a polyamide fiber and a glass fiber.

Cotton and linen are cited as examples of natural fiber.

For a polyester fiber, mention will be made of high-tenacity polyester fibers, such as polyethylene terephthalate fibers, notably DACRON®, TERYLENE® or TRERIVA® fibers.

Polyamide fiber is preferably of the PA6 type (Nylon 6) or PA 6,6 (Nylon 6,6).

The conductive metal covering the core of the fibers is advantageously chosen from nickel, a stainless steel, copper, silver, gold and their alloys.

The thickness of the metal layer on the core of the fibers ranges preferably from 0.005 to 2 μm.

Furthermore, the core of each fiber notably has a length of 0.1 to 50 mm and a diameter of 1 to 20 μm.

Identical fibers or fibers differing in the nature of their core and/or the nature of the conductive metal may be used in one and the same resistance.

As an example of fibers, mention will be made notably of carbon fibers provided with a nickel coating, known under the brand TENAX-J HTA SU 41 NI 25 and marketed by TOHO TENAX.

In order to accommodate the de-icing matting 3, the structure 1 advantageously has, on its external face, a housing 6, with dimensions substantially equal to those of the de-icing matting 3, in order to be able to accommodate the de-icing matting 3.

The structure 1 may be made according to all the methods known to those skilled in the art. It may therefore be metal or composite.

The metal shield 2 is conventionally a thin metal strip. Typically it is 0.6 mm thick in the portion 7 covering the de-icing matting 3. In order to make de-icing easier, this strip should remain fairly thin. Such a thickness may however be insufficient to achieve attachment to the structure 1. Advantageously, the metal shield 2 has a greater thickness, of the order of 3 to 5 mm in the portion 8 not covering the de-icing matting 3.

According to one embodiment, the de-icing matting 3 may be assembled, in a first operation, with the metal sheet 2. The assembly is then assembled with the structure 1 in a second operation.

The de-icing matting 3 may be assembled to the metal shield 2 by bonding. This is applicable both to an elastomer matrix and to a composite matrix.

However, in the case of a de-icing matting 3 with a composite matrix, the de-icing matting 3 may advantageously be drape-molded directly over the metal shield 2. This makes it possible, at the same time, to produce the composite de-icing matting 3 directly in its final form defined by the metal shield 2 and to attach it to the metal shield 2.

According to an alternative embodiment, the de-icing matting 3 may be assembled in a first operation with the structure 1, the metal shield 2 then being assembled with the assembly and attached to the structure 1 in a second operation.

As above, the de-icing matting 3 may be assembled on the structure 1 by bonding. In the particular case of a composite matrix, it is further possible to directly drape-mold the de-icing matting on the structure 1.

The metal shield 2 is attached to the structure 1 by any attachment means known to those skilled in the art. However, since the object is to improve maintenance, a removable attachment method, such as riveting 9 or screwing 9 is preferred. Such an attachment method allows the metal shield 2 to be removed by removing the rivets 9 or the screws 9. The de-icing matting 3 may be removed in the case of a bonded assembly by using solvent or by heating.

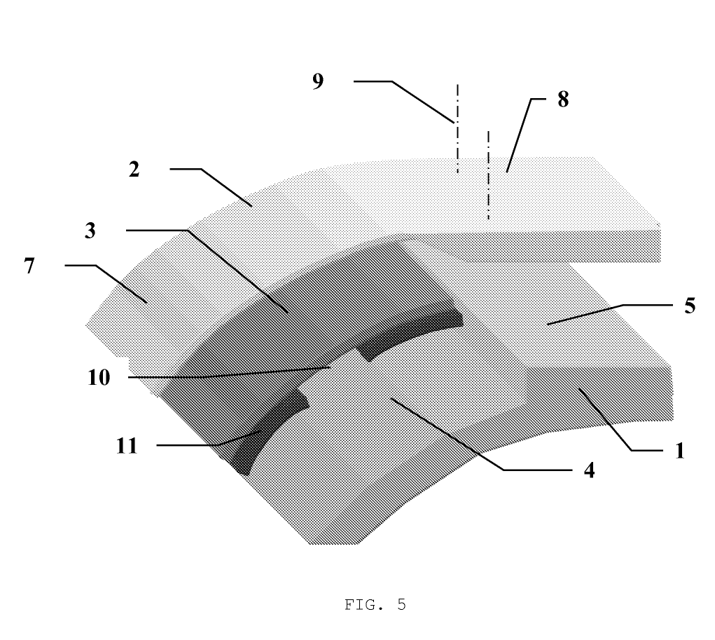

With reference to FIGS. 4 and 5, a space 10 may appear between the de-icing matting 3 and the structure 1. This space 10 may be required in order to make the manufacture or assembly easier. It may also be intentionally arranged or increased, for example by increasing the depth of the housing 6.

The effectiveness of the de-icing matting 3 is all the better if said matting 3 is flattened against the metal shield 2. For this, the assembly procedure advantageously comprises a step of injecting a filler material 11 into said space 10 delimited between the de-icing matting 3 and the structure 1. Said material 11 is injected through an opening made through the structure 1. The injection may also be achieved via the edge. The injection opening is advantageously reclosed after injection.

The filler material 11 is advantageously chosen from: a silicone gel, an elastomer in the form of self-vulcanizing paste or gel, a polyurethane foam.

Such a filler material 11 is advantageously an expanding material in order to fill the space 10 and to flatten the de-icing matting 3 against the metal shield 2. Moreover, this filler material 11 improves the thermal efficiency of the de-icing matting 3 by creating an insulating layer between the de-icing matting 3 and the structure 2. As a beam, it absorbs vibrations. It also partially protects the structure 1 from impacts by creating a deformation zone.

Such a filler material 11 also advantageously does not stick either to the surface of the structure 1, or to the de-icing matting 3, in order to make the removal of the assembly easier.

What is claimed is:

1. Method for assembling de-icing matting (3) and an external protective metal shield (2), on a structure (1), such as an airfoil leading edge structure (1), characterized in that it comprises the following steps:
manufacture of de-icing matting (3) independent of said structure (1),
installation of the de-icing matting (3), between said structure (1) and the metal shield (2), said de-icing matting (3) covering only a portion (4) of the external surface of said structure (1),
attachment of said metal shield (2), entirely covering said de-icing matting (3), to the portion (5) of the external surface of said structure (1) not covered by said de-icing matting (3).

2. Method according to claim 1, wherein the de-icing matting (3) comprises an elastomer matrix.

3. Method according to claim 1, wherein the de-icing matting (3) comprises a composite matrix.

4. Method according to claim 1, wherein the de-icing matting (3) comprises a network of heating resistances made of metal.

5. Method according to claim 1, wherein the de-icing matting (3) comprises a network of heating resistances made of conductive fibers.

6. Method according to claim 1, wherein the structure (1) has, on its external face, a housing (6) capable of accommodating the de-icing matting (3).

7. Method according to claim 1, wherein the structure (1) is metal or composite.

8. Method according to claim 1, wherein the metal shield (2) has a reduced thickness in the portion (7) covering the de-icing matting (3) and an increased thickness in the portion (8) not covering the de-icing matting (3).

9. Method according to claim 1, wherein the de-icing matting (3) is installed by prior assembly with the metal shield (2).

10. Method according to claim 9, wherein the de-icing matting (3) is bonded to the metal shield (2).

11. Method according to claim 9, wherein the composite de-icing matting (3) is drape-molded directly over the metal shield (2).

12. Method according to claim 1, wherein the de-icing matting (3) is installed by prior assembly with the structure (1).

13. Method according to claim 12, wherein the attachment of the metal shield (2) to the structure (1) is carried out by riveting or by screwing.

14. Method according to claim 12, further comprising a step of injecting a filler material (11) into a space (10) delimited between the de-icing matting (3) and the structure (1).

15. Method according to claim 14, wherein the filler material (11) is chosen from a silicone gel, an elastomer in the form of self-vulcanizing paste or gel and a polyurethane foam.
